(19) United States
(12) Patent Application Publication
(10) Pub. No.: US 2016/0217939 A1
(43) Pub. Date: Jul. 28, 2016

(54) METHOD OF MANUFACTURING ELECTRODE AND METHOD OF MANUFACTURING CAPACITOR INCLUDING ELECTRODE FORMED THEREBY

(71) Applicant: ELECTRONICS AND TELECOMMUNICATIONS RESEARCH INSTITUTE, Daejeon (KR)

(72) Inventors: Ho-Gyeong YUN, Seoul (KR); In-Kyu YOU, Gongju-si (KR)

(73) Assignee: ELECTRONICS AND TELECOMMUNICATIONS RESEARCH INSTITUTE, Daejeon (KR)

(21) Appl. No.: 15/007,757

(22) Filed: Jan. 27, 2016

(30) Foreign Application Priority Data
Jan. 27, 2015 (KR) 10-2015-0012812

(51) Int. Cl. H01G 13/00

(52) U.S. Cl. CPC H01G 13/00

(57) ABSTRACT

Provided are a method of manufacturing an electrode and a method of manufacturing a capacitor using the electrode. According to an embodiment of the inventive concept, provided is a method of manufacturing an electrode including forming stacked graphene films on a first substrate, separating the graphene films from the first substrate, cutting the graphene films to form graphene electrode parts, and transferring the graphene electrode parts to a second substrate, in which the graphene electrode parts cross a top surface of the second substrate.

### CROSS-REFERENCE TO RELATED APPLICATION

This U.S. non-provisional patent application claims priority under 35 U.S.C. §119 of Korean Patent Application No. 10-2015-0012812, filed on Jan. 27, 2015, the entire contents of which are hereby incorporated by reference.

### BACKGROUND

The present disclosure herein relates to a method of manufacturing a capacitor, and more particularly, to a method of manufacturing a capacitor including a graphene electrode.

A supercapacitor is referred to a capacitor with very large capacitance, and is a type of electrochemical capacitor and is an electrical energy storage device with a long life time and a high power, instantaneously charging a lot of electrical energy and then instantaneously or continuously discharging or supplying a high current over several seconds or several minutes. Recently, the specific capacitance of such an electrochemical capacitor has been increased more than 100 to 1000 times when compared to that of a conventional capacitor, due to advances in electrode material technology. The power density of the supercapacitor has been enhanced to more than ten times compared to that of the secondary cell, and the energy density of the supercapacitor has been enhanced to one-tenth level compared to that of the secondary cell. Thus application fields of the supercapacitor as an energy storage power source capable of rapidly storing and supplying a large amount of energy have been recently expanded.

### SUMMARY

The present disclosure provides a method of manufacturing a graphene electrode crossing a surface of a substrate.

The present disclosure also provides a method of manufacturing a capacitor using a graphene electrode crossing a surface of a substrate.

The objects of the present disclosure are not limited to the aforesaid, but other objects not described herein will be clearly understood by those skilled in the art from descriptions below.

The present disclosure relates to a method of manufacturing an electrode and a method of manufacturing a capacitor. An embodiment of the inventive concept provides a method of manufacturing an electrode including forming graphene films and binders on a first substrate, which the graphene films and the binders are alternately stacked, separating the graphene films and the binders from the first substrate, cutting the graphene films and the binders to form a graphene electrode part, transferring the graphene electrode part to a second substrate, and removing the binder. The graphene electrode parts cross a top surface of the second substrate.

In an embodiment, the forming the graphene films and the binders may include a spin-coating process.

In an embodiment, the cutting the graphene films and the binders may include a wire-cutting process or a laser-cutting process.

In an embodiment of the inventive concept, a method of manufacturing a capacitor includes forming a first graphene electrode part on a first substrate, forming a second graphene electrode part on a second substrate, and coupling the first and second graphene electrode parts to each other such that the first and second graphene electrode parts face each other. The first graphene electrode part crosses a top surface of the first substrate, and the second graphene electrode part crosses a top surface of the second substrate, and the forming the graphene electrode parts includes forming graphene films and binders on a third substrate, which the graphene films and the binders are alternately stacked, separating the graphene films and the binders from the third substrate, cutting the graphene films and the binders to form graphene patterns, transferring the graphene patterns to the first and second substrates, and removing the binder.

In an embodiment, the coupling the first and second graphene electrode parts to each other may include disposing second graphene patterns between first graphene patterns, respectively. The second graphene patterns may be spaced apart from the first graphene patterns and the first substrate and the first graphene patterns may be spaced apart from the second substrate.

In an embodiment, the coupling the first and second graphene electrode parts together may further include forming a separation membrane between the first and second graphene electrode parts.

In an embodiment, the method may further include providing an electrolyte between the first and second substrates.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 illustrates a perspective view of an electrode according to embodiments of the inventive concept,

FIGS. 2 to 7 are perspective views illustrating a method of manufacturing an electrode according to embodiments of the inventive concept,

FIG. 8 illustrates a cross-sectional view of a capacitor according to one embodiment of the inventive concept, and

FIG. 9 illustrates a cross-sectional view of a capacitor according to one embodiment of the inventive concept.

### DETAILED DESCRIPTION

The objects, other objects, features, and advantages of the present invention will be readily understood through embodiments related to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

As used herein, the term ‘and/or’ includes any and all combinations of one or more of the associated listed items. In addition, the term ‘connected to’ or ‘coupled to’ may be used to refer to a component directly connected to, coupled to, or interposed between other components.

In the specification, it will be understood that when a film (or layer) is referred to as being ‘on’ another film (or layer) or substrate, it can be directly on the other film (or layer) or substrate, or intervening films (or layers) may also be present. In the following description, the technical terms are used only for explaining a specific exemplary embodiment while not limiting the present invention. The terms of a singular form may include plural forms unless referred to the contrary. The meaning of “include,” “comprise,” “including,” or “comprising,” specifies a component, a step, an operation and/or a device but does not exclude other components, steps, operations and/or devices.

Although the terms, such as first, second, and third may be used herein to describe various regions, films (or layers), and the like, the regions, films (or layers), and the like should not be limited by these terms. These terms are used only to discriminate one region or film (or layer) from another region or film (layer). Therefore, a film (or layer) referred to as a first film (or layer) in one embodiment can be referred to as a second film (or layer) in another embodiment. An embodiment described and exemplified herein includes a complementary embodiment thereof. Like reference numerals refer to like elements throughout the specification.

Exemplary embodiments of the present disclosure are described herein with reference to plan illustrations and cross-sectional illustrations that are schematic illustrations of idealized example embodiments of the present disclosure. Also, in the drawings, the thickness or size of each element are exaggerated for clarity of illustration. As such, variations from the shapes of the illustrations as a result, for example, of manufacturing techniques and/or tolerances, are to be expected. Thus, example embodiments of the present disclosure should not be construed as limited to the particular shapes of regions illustrated herein but are to include deviations in shapes that result, for example, from manufacturing. For example, an etched region illustrated as a right angle may have rounded or curved features. Thus, the regions illustrated in the figures are schematic in nature and their shapes are not intended to illustrate the actual shape of a region of a device and are not intended to limit the scope of the present invention.

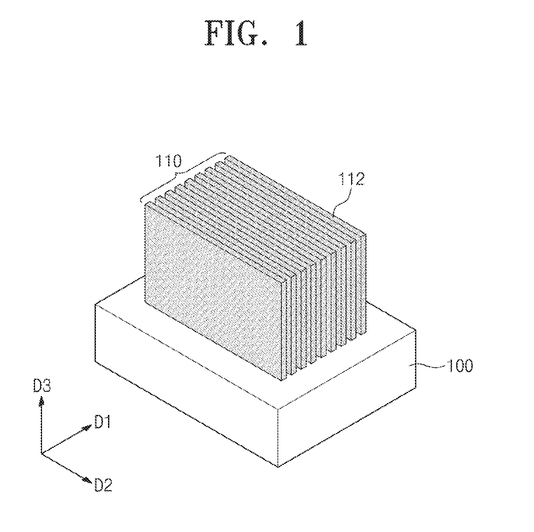

FIG. 1 illustrates a perspective view of an electrode according to embodiments of the inventive concept.

Referring to FIG. 1, an electrode may include a substrate 100 and a graphene electrode part 110 on the substrate 100.

The substrate 100 may be a metal-based substrate. For example, the substrate 100 may be a polymer substrate, a substrate coated with a metal material such as aluminum, a metal substrate, a metal foil, or a substrate in which silicon and glass are mixed.

The graphene electrode part 110 may include graphene films 112 spaced apart from each other side by side, respectively. The graphene films 112 may be oriented in the same direction. The graphene films 112 may cross a top surface of the substrate 100. For example, the graphene films 112 may be perpendicular to a top surface of the substrate 100. A whole bottom surface of the graphene electrode part 110 may contact the whole top surface or a portion of the top surface of the substrate 100. Separation distances between the graphene films 112 may be the same. However, the separation distances may be different from each other as necessary. Although nine graphene films 112 are illustrated in FIG. 1, the number of the graphene films 112 is not limited thereto. The graphene films 112 may include a graphene material or a graphene oxide material. The graphene films 112 may further contain a conductive material, an oxide, a nitride, or the like. For example, the oxide may include a lithium-containing metal oxide, a lead-containing oxide, a manganese-containing oxide, a ruthenium-containing oxide, a vanadium-containing oxide, a cobalt-containing oxide, or a nickel-containing oxide. The nitride may include a vanadium-containing nitride. In one example, a conductive polymer material may be additionally provided to the graphene films 112. For example, the conductive polymer material may include polyaceltylene, polyaniline, polypyrrole, polythiophene, poly(3,4-ethylenedioxythiophene), or poly(phenyl vinylene). However, the conductive polymer material is not limited to the above examples and may include a mixture of conductive polymer materials, a mixture with a non-conductive polymer material, polymer materials with different conductivities, or the like. The conductive polymer material may have an electrically conductive property while being a plastic.

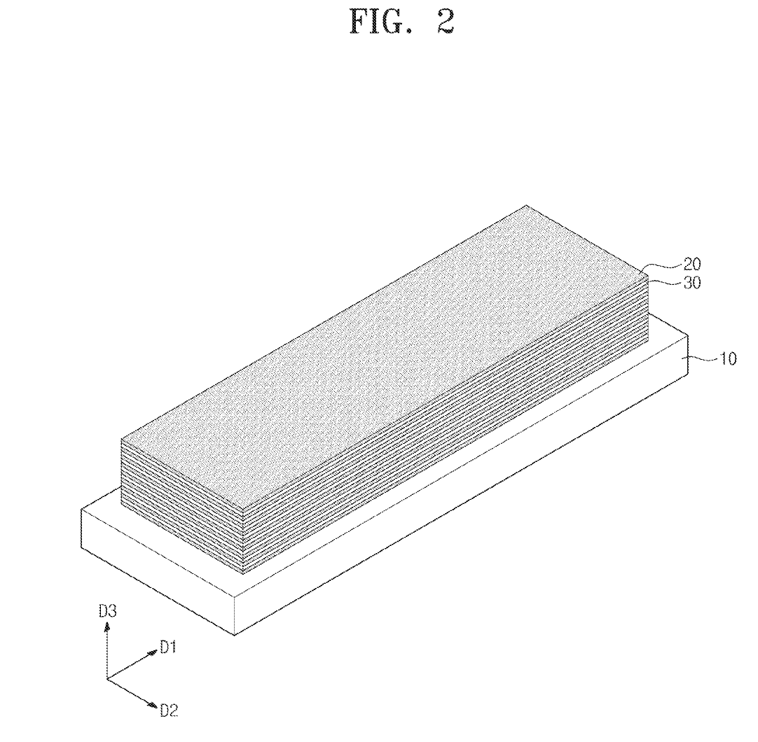

FIGS. 2 to 7 are perspective views illustrating a method of manufacturing an electrode according to embodiments of the inventive concept.

Referring to FIG. 2, graphene films 20 and binders 30 may be alternately stacked on a first supporting substrate 10. Surfaces of the graphene films 20 may be formed parallel to a top surface of the first supporting substrate 10. The graphene films 20 may be formed by a coating method. For example, the graphene films 20 may be formed by a spin coating method, a dipping method, a casting method, a screen printing method, an inkjet printing method, an offset printing method, a gravure printing method, a stamping method, a spraying method, an air doctor coater method, a blade coater method, a rod coater method, a knife coater method, a squeeze coater method, a reverse roll coater method, a transfer roll coater method, a gravure coater method, a kiss coater method, a cast coater method, a spray coater method, a slit orifice coater method, a calendar coater method, or the like. Although nine graphene films 20 are illustrated in the drawings, the number of the graphene films 20 is not limited thereto.

The binder 30 may be formed between the respective graphene films 20. The binder 30 may be formed parallel to the top surface of the first supporting substrate 10 and the graphene films 20. The binder 30 may be formed by any one of the coating methods as disclosed in the description of the graphene films 20. For example, the binder 30 may be formed by a spin coating method. Examples of the binder 30 may include polyvinylidene fluoride (PVDF), polyacrylic acid (PAA), and the like. The binder 30 may bond surfaces of the graphene films 20 to each other.

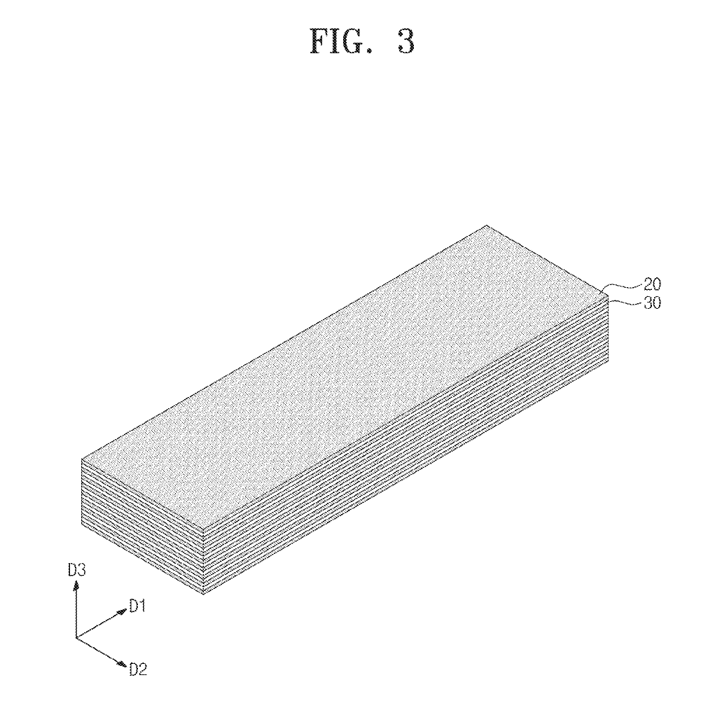

Referring to FIG. 3, the graphene films 20 and the binders 30 may be separated from the first supporting substrate 10. For example, the graphene films 20 and the binders 30 may receive a force in a direction allowing the graphene films 20 and the binders 30 to be detached from the first supporting substrate 10. The force may separate the graphene films 20 and the binder 30 from the first supporting substrate 10.

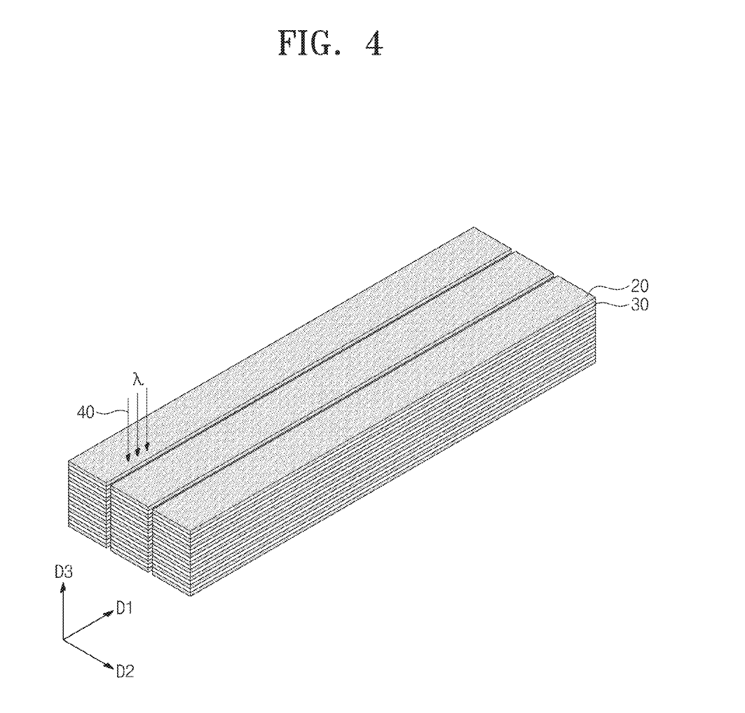

Referring to FIG. 4, the graphene films 20 and the binders 30 may be cut in a first direction D1. The first direction D1 may be parallel to the surfaces of the graphene films 20. The cutting may be performed once or more. When the cutting is performed three times or more, intervals between the cut parts may be the same. However, the intervals may be different from each other as necessary. The graphene films 20 and the binders 30 may be cut by a wire cutting process or a laser cutting process. For example, the wire cutting may use a blade, a diamond coating wire, or the like. For example, the laser cutting process may use a laser 40. The laser cutting process may be preferably used. The laser cutting process may be useful to prevent burr, thermal deformation, and the like which may occur during the cutting process.

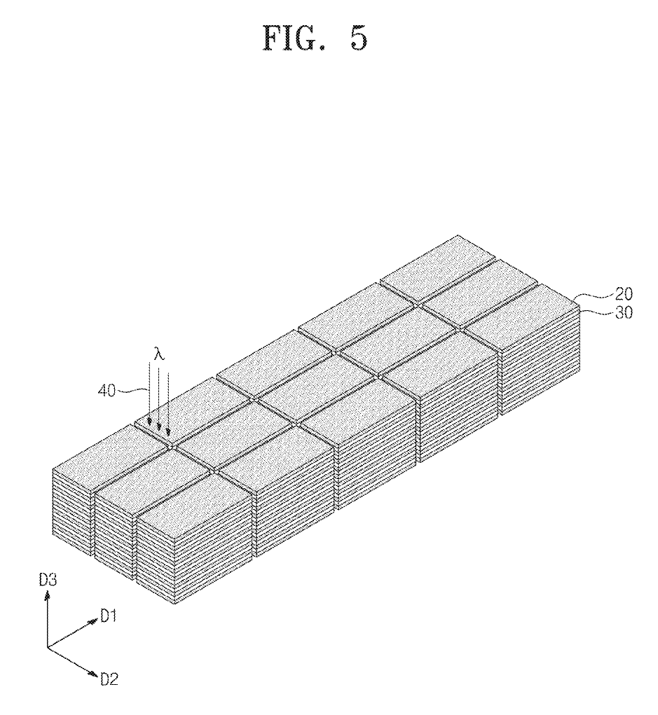

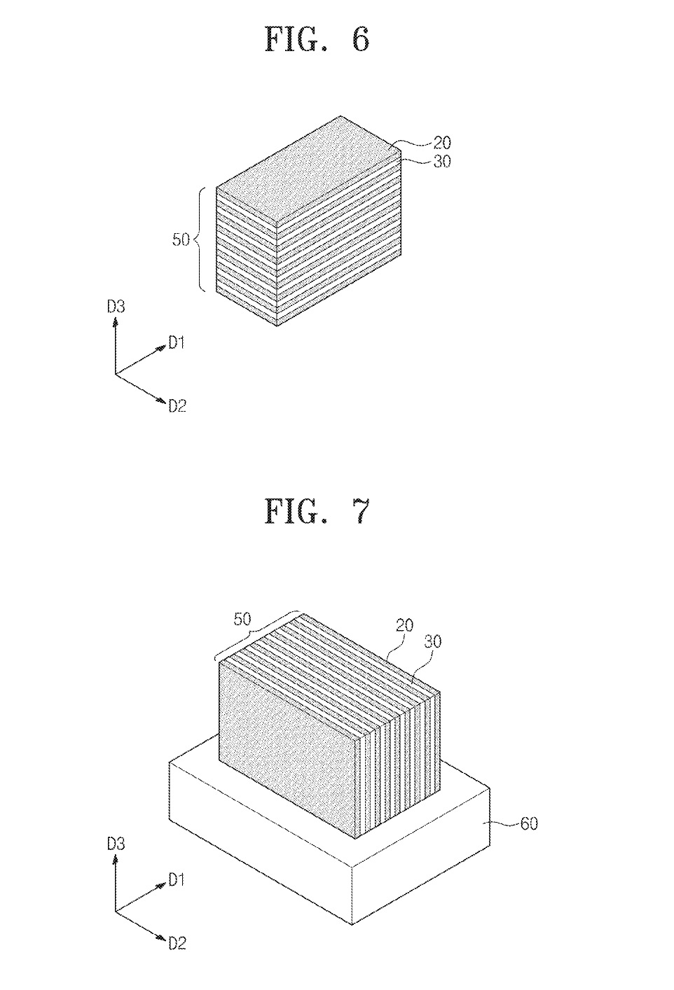

Referring to FIGS. 5 and 6, the graphene films 20 and the binders 30 may be cut in a second direction D2 perpendicular to the first direction D1. The cut graphene films 20 may be defined graphene patterns. The second direction D2 may be parallel to the surfaces of the graphene films 20. The cutting may be performed once or more. When the cutting is performed three times or more, intervals of the cut parts may be same. However, the intervals may be different from each other as necessary. The graphene films 20 and the binders 30 may be cut by a wire cutting process or a laser cutting process. Accordingly, a graphene electrode part 50 in FIG. 6 may be obtained.

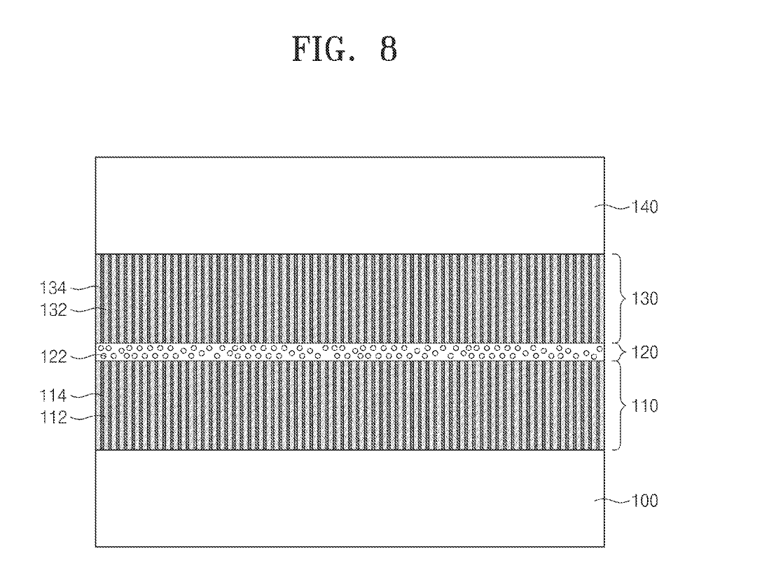

Referring to FIG. 7, the graphene electrode part 50 may be formed on a second supporting substrate 60. For example, the graphene electrode part 50 may receive a force exerted in a direction perpendicular to a top surface of the second supporting substrate 60. The force may allow the graphene electrode part 50 to be formed on the second supporting substrate 60. Surfaces of the graphene films 20 and the binders 30 which constitute the graphene electrode part 50 may cross the top surface of the second supporting substrate 60. For example, the surfaces of the graphene films 20 and the binders 30 may be perpendicular to the top surface of the second supporting substrate 60.

Referring back to FIG. 1, in one embodiment, the binders 30 may be removed from the graphene electrode part 50. For example, the binders 30 may be removed by an annealing. In another embodiment, the binders 30 may not be removed.

A direction of electrical conduction in the graphene films 20 may be parallel to the surfaces of the graphene films 20. Therefore, an electrode including the graphene electrode part 50 formed to cross the surface of the second supporting substrate 60 may have a more improved electrical conductivity than an electrode including a graphene electrode part (not shown) formed parallel to the surface of the second supporting substrate 60. In other words, an electrode including the graphene films 20 formed to cross the surface of the second supporting substrate 60 may have a more improved electrical conductivity than a conventional electrode including a graphene film (not shown) formed parallel to the surface of the second supporting substrate 60.

Accordingly, an electrode with an improved electrical property may be obtained.

FIG. 8 illustrates a cross-sectional view of a capacitor according to one embodiment of the inventive concept.

Referring to FIG. 8, a capacitor may include a first substrate 100 and a second substrate 140 which face each other, a first graphene electrode part 110 formed on the first substrate 100, a second graphene electrode part 130 formed under the second substrate 140, and a separation membrane 120 provided between the first and second graphene electrode parts 110 and 130.

The first and second substrates 100 and 140 may be metal-based substrates. For example, each of the first and second substrates 100 and 140 may be a polymer substrate, a substrate coated with a metal material such as aluminum, a metal substrate, a metal foil, or a substrate in which silicon and glass are mixed.

The first and second graphene electrode parts 110 and 130 may have the same structure. However, the first and second graphene electrode parts 110 and 130 may have different structures as necessary. The first graphene electrode part 110 may include first graphene films 112 crossing a top surface of the first substrate 100 and an electrolyte 114 filling between the respective first graphene films 112. The second graphene electrode part 130 may include second graphene films 132 crossing a bottom surface of the second substrate 140 facing the top surface of the first substrate 100 and an electrolyte 134 filling spaces between the respective second graphene films 132. In one embodiment, the first and second graphene films 112 and 132 may cross the top surface of the first substrate 100 and the bottom surface of the second substrate 140, respectively.

The respective graphene films 112 may be spaced apart from each other. Separation distances between the respective graphene films 112 may be the same. The respective graphene films 132 may be spaced apart from each other. Separation distances between the respective graphene films 132 may be the same. However, the separation distances may be different from each other as necessary. Areas of the first and second graphene films 112 and 132 may be appropriately determined. For example, the areas of the first and second graphene films 112 and 132 may be determined by a cutting process that is the same as the cutting process described above in relation to FIGS. 2 to 7. Thicknesses of the respective graphene films 112 and 132 may be the same to each other. The thicknesses of the respective first and second graphene films 112 and 132 may range from about a few hundred nanometers to about a few hundred micrometers. When the first and second graphene films 112 and 132 are too thin, the energy storage capacity of the capacitor is reduced, and when the first and second graphene films 112 and 132 are too thick, a material cost is increased and the electrolytes 114 and 134 may not smoothly move.

The electrolytes 114 and 134 may fill all or a portion of spaces between the first graphene films 112 and all or a portion of spaces between the second graphene films 132. In addition, the electrolytes 114 and 134 may fill all or a portion of pores 122 included in the separation membrane 120 to be described below. The electrolytes 114 and 134 may be organic electrolytes or mixtures thereof which include a non-lithium salt such as TEABF4 or TEMABF4, at least one lithium salt selected from a group consisting of LiPF₆, LiBF₄, LiCLO₄, LiN(CF₃SO₂)₂, CF₃SO₃Li, LiC(SO₂CF₃)₃, LiAsF₆, and LiSbF₆.

Referring back to FIG. 7, in one embodiment, the electrolytes 114 and 134 may be filled between graphene particles included in the graphene films 112.

The separation membrane 120 may be formed between the first and second graphene electrode parts 110 and 130 to cover both the top surface of the first graphene electrode part 110 and the bottom surface of the second graphene electrode part 130. The separation membrane 120 plays a role of preventing a short circuit due to a contact between the first and second graphene electrode parts 110 and 130. The separation membrane 120 may include pores 122. The separation membrane 120 may be a microporous film made of one polymer selected from the group consisting of, for example, polyethylene (PE), polypropylene (PP), polyvinylidene fluoride (PVDF), polyvinylidene chloride, polyacrylonitrile (PAN), polyacrylamide (PAAm), polytetrafluoroethylene (PTFE), polysulfone, polyether sulfone (PES), polycarbonate (PC), polyamide (PA), polyimide (PI), polyethylene oxide (PEO), polypropylene oxide (PPO), a cellulose-based polymer, a polyacrylic-based polymer, and a combination thereof.

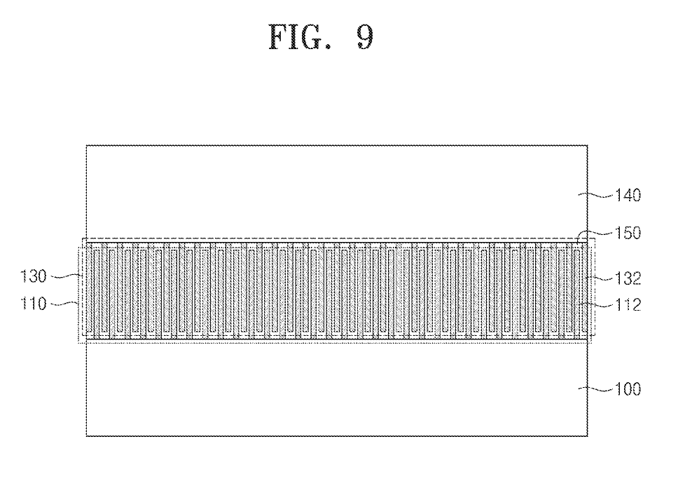

FIG. 9 illustrates a cross-sectional view of a capacitor according to one embodiment of the inventive concept. For simplicity of description, in the embodiment illustrated in FIG. 9, the same reference numerals will be given to substantially the same components as those of the previous embodiments and duplicate description thereof will not be repeated.

Referring to FIG. 9, a capacitor may include a first substrate 100 and a second substrate 140 which face each other, a first graphene electrode part 110 formed on the first substrate 100, and a second graphene electrode part 130 formed under the second substrate 140.

The respective first graphene films 112 included in the first graphene electrode part 110 may be spaced apart from each other. The respective second graphene films 132 included in the second graphene electrode part 130 may be spaced apart from each other. The respective first graphene films 112 may be located between the respective second graphene films 132 spaced apart from each other. The respective first graphene films 112 and the respective second graphene films 132 may be spaced apart from each other. A top surface of the first graphene electrode part 110 may be spaced apart from a bottom surface of the second substrate 140. A bottom surface of the second graphene electrode part 130 may be spaced apart from a top surface of the first substrate 100.

An electrolyte 152 may be filled in spaces spaced apart between the first substrate 100, the first graphene films 110, the second substrate 140, and the second graphene films 130.

Accordingly, since the first and second graphene films 110 and 130 oriented to cross the surfaces of the first and second substrates 100 and 140 have a large surface area, electrons may smoothly move. Therefore, a capacitor with excellent electrochemical properties may be realized.

As described above, a capacitor according to embodiments of the inventive concept includes an electrode with graphenes oriented to cross a surface of the substrate. Since the graphenes allow electrons to move more smoothly than graphenes horizontally oriented on the substrate, a capacitor with excellent electrochemical properties may be realized.

A method of manufacturing an electrode and a capacitor according to embodiments of the inventive concept includes cutting graphene films coated with a plurality of layers to provide a graphene electrode part such that the graphene films cross a surface of the substrate. Accordingly, the graphene films may be oriented to cross the surface of the substrate without expensive process costs.

Those skilled in the art to which the present disclosure pertains will appreciate that the present disclosure may be implemented in other detailed forms without departing from the technical spirit or essential characteristics of the present disclosure. Accordingly, the aforementioned various embodiments should be constructed as being only illustrative not as being restrictive from all aspects. The scope of the present disclosure is defined by the appended claims rather than the foregoing description and all changes or modifications or their equivalents made within the meanings and scope of the claims should be construed as falling within the scope of the present disclosure.

What is claimed is:

1. A method of manufacturing an electrode, the method comprising:
forming graphene films and binders on a first substrate, which the graphene films and the binders are alternately stacked;
separating the graphene films and the binders from the first substrate;
cutting the graphene films and the binders to form a graphene electrode part;
transferring the graphene electrode part to a second substrate; and
removing the binders,
wherein the graphene electrode parts cross a top surface of the second substrate.

2. The method of claim 1, wherein the forming the graphene films and the binders comprises a spin-coating process.

3. The method of claim 1, wherein the cutting the graphene films and the binders comprises a wire-cutting process or a laser-cutting process.

4. A method of manufacturing a capacitor, the method comprising:
forming a first graphene electrode part on a first substrate;
forming a second graphene electrode part on a second substrate; and
coupling the first and second graphene electrode parts to each other such that the first and second graphene electrode parts face each other,
wherein the first graphene electrode part crosses a top surface of the first substrate, and the second graphene electrode part crosses a top surface of the second substrate, and
wherein the forming the graphene electrode parts comprises:
forming graphene films and binders on a third substrate, which the graphene films and the binders are alternately stacked;
separating the graphene films and the binders from the third substrate;
cutting the graphene films and the binders to form graphene patterns;
transferring the graphene patterns to the first and second substrates; and
removing the binder.

5. The method of claim 4, wherein the coupling the first and second graphene electrode parts to each other comprises disposing second graphene patterns between first graphene patterns, respectively, wherein the second graphene patterns are spaced apart from the first graphene patterns and the first substrate and the first graphene patterns are spaced apart from the second substrate.

6. The method of claim 4, wherein the coupling the first and second graphene electrode parts together further comprises forming a separation membrane between the first and second graphene electrode parts.

7. The method of claim 4, further comprising providing an electrolyte between the first and second substrates.
